(19) United States
(12) Patent Application Publication
(10) Pub. No.: US 2008/0185547 A1
(43) Pub. Date: Aug. 7, 2008

(54) Fluid pressure control device and method for composing fluid pressure control device

(75) Inventor: Matsuhisa Tsuruta, Toyota-City (JP)

Correspondence Address: POSZ LAW GROUP, PLC, 12040 SOUTH LAKES DRIVE, SUITE 101, RESTON, VA, 20191, US

(73) Assignee: ADVICS CO., LTD., Kariya-city (JP)

(21) Appl. No.: 12/010,901

(22) Filed: Jan. 31, 2008

(30) Foreign Application Priority Data
Feb. 1, 2007 (JP) 2007-023192

(51) Int. Cl. F16K 31/02

(52) U.S. Cl. 251/129.15; 29/890.124

(57) ABSTRACT

A fluid pressure control device includes a body, a valve unit, a solenoid externally fitted to the valve unit, a board, and a solenoid terminal connected with the board. The fluid pressure control device further includes a spacer which is made of elastic material and located between the solenoid and the board. The fluid pressure control device also includes a case accommodating the solenoid, the board, and the spacer.

### CROSS REFERENCE TO RELATED APPLICATION

This application is based on and incorporates herein by reference Japanese patent applications No. 2007-023192 filed on Feb. 1, 2007.

### FIELD OF THE INVENTION

The present invention relates to a fluid pressure control device which has a solenoid valve for opening and closing a fluid channel and also has a board at which an electrical element is arranged. In addition, the present invention relates to a method for composing the fluid pressure control device. In particular, the present invention is suitable for a fluid pressure control device used for the vehicular brake device.

### BACKGROUND OF THE INVENTION

A conventional fluid pressure control device shown in FIG. 18 includes a body 1 having a fluid channel through which brake fluid flows. As shown in FIG. 18, solenoid valves 2 for opening and closing a fluid channel are mounted on the body 1. The case 3 is formed by connecting a solenoid housing 32 with a connector housing 33 through a connecting portion 1A. The solenoid valves 2 respectively include solenoids 21 which are located in a solenoid chamber 2A formed by the solenoid housing 32.

A resin cover 3A is attached to the case 3 and forms a board chamber 4A. The board chamber 4A and the solenoid chamber 2A are separated from each other by a partitioning wall 5A of the case 3. A board 5 is located in the board chamber 4A and is supported by board holding members 6A of the case 3.

Solenoid terminals 22 of the solenoid valves 2 extends from the solenoid chamber 2A to the board chamber 4A, penetrating the partitioning wall 5A. The solenoid terminals 22 are accordingly connected with the board 5. Ends of the connector terminals 4 formed by insert molding are attached to the board 5.

The case 3 and the cover 3A are welded together at an open end of the cover 3A. Seal members are inserted to portions of the partitioning walls which the solenoid terminals 22 penetrate. Thus, airtightness of the board chamber 4A is attained. A contacting surface between the body 1 and the case 3 are sealed by a packing 35.

The solenoids 21 are pushed by springs (waved washers) 7A located between the solenoid 21 and the body 1 and are accordingly pressed against stoppers 8A formed at the case 3. Thus, the solenoids 21 are positioned by the springs 7A and the stoppers 8A. Therefore, the solenoids 21 can be moved apart along with the case 3 and the board 5 from the body 1 when bolts fixing the case 3 to the body 1 are removed. The fluid pressure control device in which the solenoids 21 can be put off from the body 1 is described in JP 2005-29110A.

The solenoid terminals 22 can be connected with the board 5 by means of a known method such as solder jointing and a method for using press fit terminals as solenoid terminals 22 (see JP 2004-273256A)

However, each of the conventional fluid pressure control devices includes the solenoid chamber 2A and board chamber 4A separately, and the partitioning wall 5A and the cover 3A are therefore necessary. This causes raise in manufacturing cost of the fluid pressure control device. The amount of the raise increases as the size of the fluid pressure control device increases.

In addition, a large amount of portions which need sealing causes rise in risk to the reliability of sealing of the fluid pressure control device as well as rise in the manufacturing cost of the fluid pressure control device.

Moreover, the solenoid 21 are not firmly positioned relative to the case 3 and the board 5 until they are connected with the body 1 along with the case 3 and the board 5. Therefore, there is a possibility that connecting portion at which the solenoid terminals 22 and the board 5 are connected are broken or that the solenoid terminals 22 are broken because of vibration in transporting a collective of the solenoid 21, case 3 and the board 5.

Furthermore, in the case that press the fit terminals are used as the solenoid terminals 22, the solenoid terminals 22 and board 5 are connected together only by means of friction forces generated at portions of the solenoid terminals 22 pressed by the board 5. Therefore, the solenoid terminals 22 are likely to get off from the board 5.

### SUMMARY OF THE INVENTION

It is therefore an object of the present invention to reduce the size and the manufacturing cost of a fluid pressure control device. It is another object of the present invention to improve reliability of sealing of a fluid pressure control device. It is another object of the present invention to improve reliability of a connecting portion between a solenoid terminal and a board.

According to an aspect of the present invention, a fluid pressure control device includes a body in which fluid flows. It also includes a solenoid valve including: a valve unit for allowing and blocking flow of the fluid; and a solenoid externally fitted to the valve unit in a detachable manner. The fluid pressure control device also includes a solenoid terminal connected with the solenoid; a board including a surface on which an electrical element is arranged, the board connected with the solenoid terminal; a spacer including elastic material, the spacer located between the solenoid and the board; and a case attached to the body, the case accommodating the solenoid, the board, and the spacer. In addition, the board and the spacer are held between the solenoid and the case.

With the fluid pressure control device described above, a conventional partitioning wall and a conventional cover for covering the partitioning wall can be disused. It is therefore possible to manufacture the fluid pressure control device with a small size and a low manufacturing cost.

In addition, portions which need sealing decrease, sealing of the fluid pressure control device becomes more reliable.

In addition, the spacer prevents a displacement of the solenoid relative to the board in a state before a collective in which the solenoid, the board, the spacer, and the case are combined together are attached to the body. In other words, the spacer suppresses wobbling of the solenoid in the state. Therefore, it is possible to prevent the solenoid terminal and a connecting portion at which the solenoid terminal and the board are connected from being broken because of vibration in transporting the collective.

In addition, the spacer also suppresses wobbling of the solenoid in a state after the collective of the solenoid, the board, the spacer, and the case are attached to the body. Therefore, it is possible to improve reliability of the connecting portion between the solenoid terminal and the board.

The spacer may include a sandwiched portion, the sandwiched portion located between the board and a surface of the solenoid, the sandwiched portion compressed.

With this configuration, wobbling of the solenoid is further suppressed since a bouncing force of the sandwiched portion pushes the solenoid against the body. The connecting portion between the solenoid terminal and the board are further secured.

The spacer may include a guide portion extending from the sandwiched portion in an axial direction of the solenoid and holding an outer periphery of the solenoid.

With this configuration, the guide portion suppresses wobbling of the solenoid relative to the board and accordingly prevents the solenoid terminal from being bent. Therefore, the connecting portion between the solenoid terminal and the board are further secured.

The spacer may include an arm portion extending from the guide portion to a side face of the case, the side face facing the outer periphery of the solenoid, the arm portion including a tip portion coming in contact with the side face.

With this configuration, the guide portion further suppresses wobbling of the solenoid relative to the board and accordingly prevents the solenoid terminal from being bent. Therefore, the connecting portion between the solenoid terminal and the board are furthermore secured.

The arm portion may be compressed.

With this configuration, a bouncing force of the arm portion generates a friction force between the guide portion and the outer periphery of the solenoid. Therefore, the guide portion further suppresses wobbling of the solenoid. As a result, the connecting portion between the solenoid terminal and the board are furthermore secured.

In addition, it is possible to prevent a collective in which the solenoid, board, and the spacer are combined together from failing off from the case.

The spacer may include a protrusion portion, and the board may include a recessed portion. In addition, the protrusion portion may be fitted in the recessed portion and the board may be accordingly connected with the spacer.

The case may include a pillar inserted to a hole formed at the board.

With this configuration, it is possible to surely locate the board to a proper position relative to the case.

The solenoid terminal may be a press fit terminal.

With this configuration, the solenoid terminal can be easily moved relative to the body in attaching the collective of the solenoid, board, spacer, and the case to the body, in other words, in compressing the sandwiched portion of the spacer.

The fluid pressure control device may be incorporated to a vehicle; and brake fluid flows in the body.

The fluid pressure control device may be composed in a method including the following three steps. A first step is for obtaining a first collective in which the solenoid, the board, and the spacer are combined together. The first step includes disposing the spacer between the solenoid and the board and inserting the solenoid terminal to a hole formed at the board. A second step is for obtaining a second collective. The second step includes locating the first collective in the case and forming the second collective by combining the first collective and the case. A third step is for combining the second collective to the body.

### BRIEF DESCRIPTION OF THE DRAWINGS

The invention, together with additional objective, features and advantages thereof, will be best understood from the following description, the appended claims and the accompanying drawings. In the drawings:

FIG. 1 is a plan view showing a fluid pressure control device according to a first embodiment;

FIG. 2 is a cross-sectional view taken along the II-II line in FIG. 1;

FIG. 3 is a cross-sectional view taken along the III-III line in FIG. 2;

FIG. 4 is a cross-sectional view taken along the IV-IV line in FIG. 3;

FIG. 5 is a cross-sectional view of a solenoid valve taken along the V-V line in FIG. 3;

FIG. 6 is a cross-sectional view showing a portion at which a connector terminal and a board shown in FIG. 2 are connected;

FIG. 7 is a plan view of a spacer shown in FIG. 2;

FIG. 8 is a view taken in the direction of the VIII-VIII line in FIG. 7;

FIG. 9 is a view taken in the direction of the IX-IX line in FIG. 7;

FIG. 10 is a view taken in the direction of the X-X line in FIG. 9;

FIG. 11 is a cross-sectional view taken along the XI-XI line in FIG. 7;

FIG. 12 is a cross-sectional view taken along the XII-XII line in FIG. 10;

FIG. 13 is a plan view showing a main part of a fluid pressure control device according to a second embodiment;

FIG. 14 is a cross-sectional view taken along the XIV-XIV line in FIG. 13;

FIG. 15 is a plan view of a spacer shown in FIG. 14;

FIG. 16 is a view taken in the direction of the XVI-XVI line in FIG. 15;

FIG. 17 is a view taken in the direction of the XVII-XVII line in FIG. 15; and

FIG. 18 is a cross-sectional view showing a main part of a fluid pressure control device used for a conventional vehicular brake device.

### DETAILED DESCRIPTION OF THE EMBODIMENTS

### First Embodiment

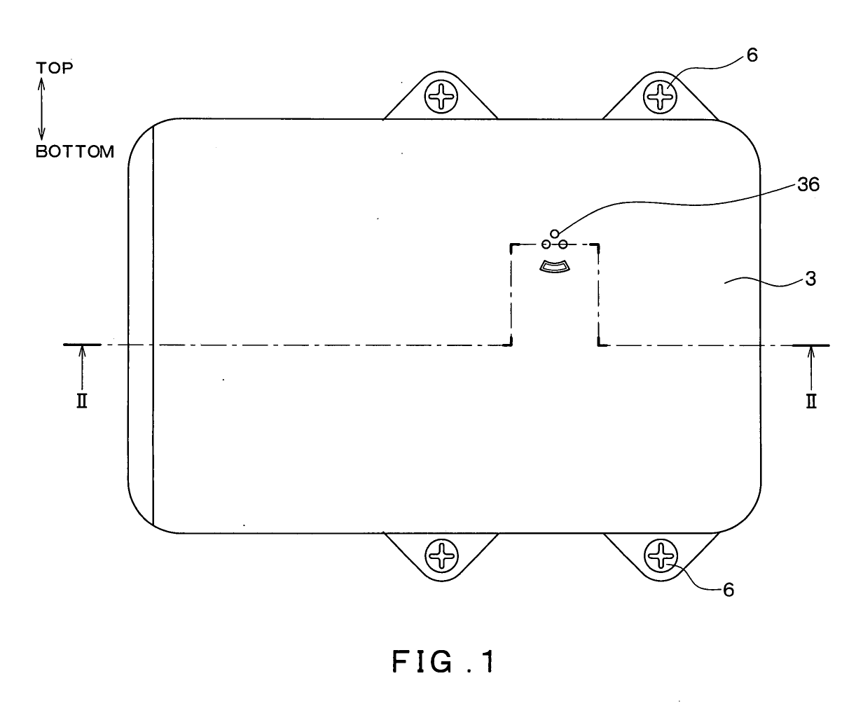

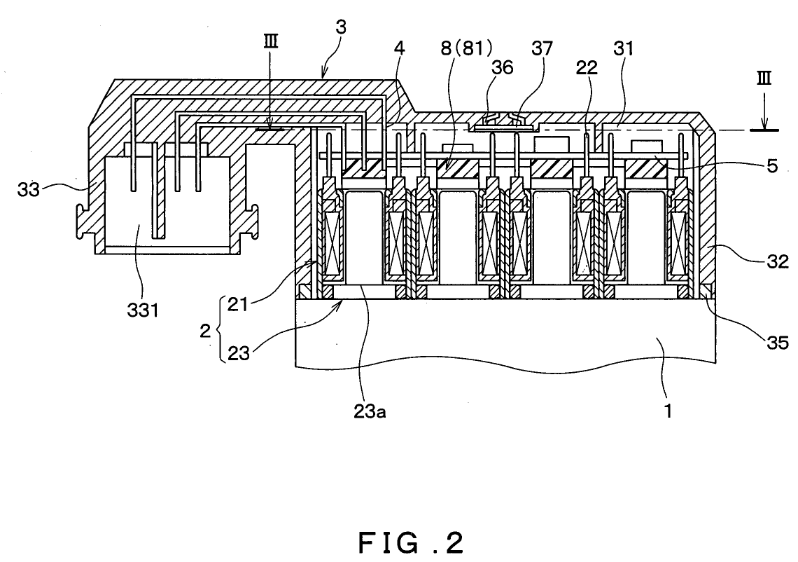

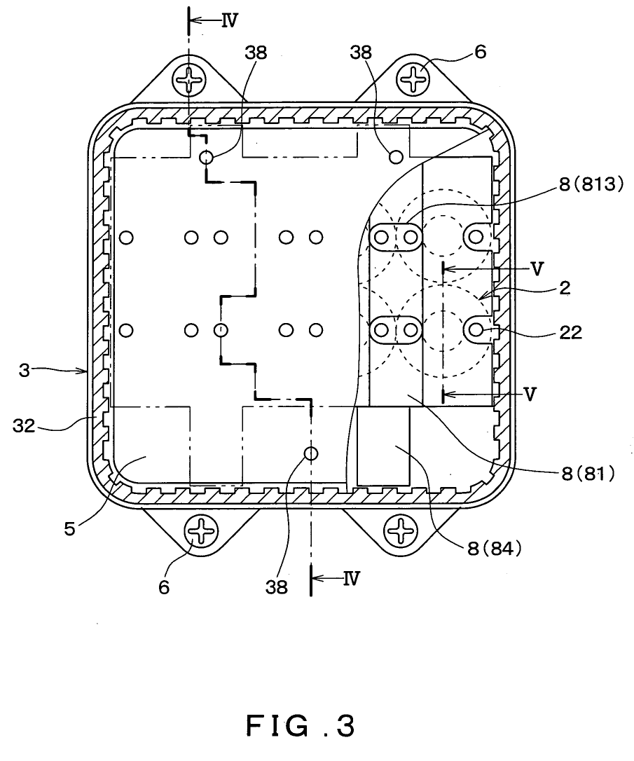

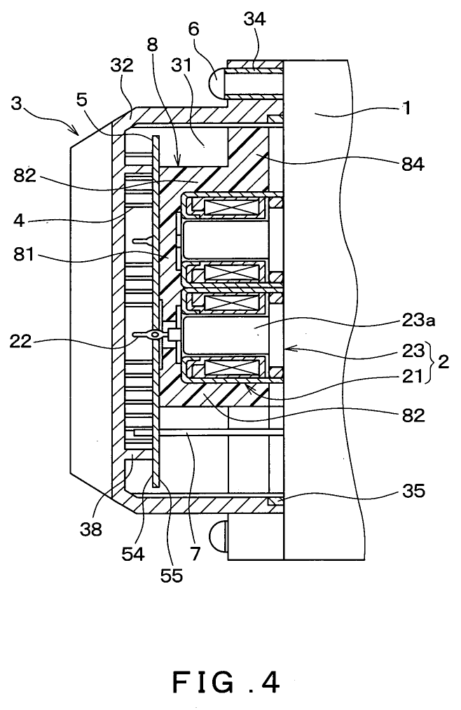

Hereinafter, a first embodiment of the present invention is described with reference to FIGS. 1 to 6.

A fluid pressure control device of the present embodiment is used for a vehicular brake device which controls a brake fluid pressure to control a braking force of a vehicle. The upward direction and the downward direction in FIG. 1 correspond respectively to the upward direction and the downward direction with reference to the vehicle to which the fluid pressure control device is installed.

As shown in FIGS. 1 to 4, the fluid pressure control device includes a metal body 1 having a fluid channel (not shown) through which brake fluid flows. A plurality of solenoid valves 2 for opening and closing the fluid channel to allow and block flow of the fluid, a pump (not shown) for sucking and discharging the brake fluid, and an electrical motor (not shown) for driving the pump are installed to the body 1.

Each of the solenoid valves 2 includes a valve unit 23 having a valve body (not shown) for opening and closing the fluid channel and also includes a solenoid 21 which draws the valve body on receiving an electrical current. The solenoid 21 is externally fitted to a sleeve 23a of the valve unit 23 at the periphery of the sleeve 23a in a detachable manner.

A resin case 3 is attached to the body 1 so that the case 3 covers the solenoids 21 and the like. Four metal bushes 34 and a lot of connector terminal 4 are formed in the case 3 through insert molding. The case 3 include a solenoid housing 32 and a connector housing 33, each having a shape similar to rectangular parallelepiped. The solenoid housing 32 forms an unpartitioned chamber 31 for accommodating the solenoids 21, a plate-like board 5, and a spacer 8 described below. The connector housing 33 forms a space 331 for accommodating an end of each of the connector terminals 4. When an external connector (not shown) is attached to the connector housing 33, connector terminals of the external connector are connected with the connector terminals 4 of the fluid pressure control device.

The case 3 is fixed to the body 1 at the bushes 34 by means of four screws 6. A surface at which the case 3 and the body 1 are contacted with each other is sealed with a packing 35.

A communicating hole 36 is formed at the case 3. The chamber 31 formed by the solenoid housing 32 communicates with the outside of the case 3 through the communicating hole 36. The communicating hole 36 prevents the chamber 31 from having a negative pressure. The communicating hole 36 is covered with a filter 37 through which gas can pass and fluid cannot pass. A plurality of pillars 38 protruding toward the board 5 are integrally formed with the case 3.

Electric elements (not shown) are arranged on a surface 54 of the board 5 and are attached to the board 5 by soldering. In addition, the board 5 is connected with the other end of each of the connector terminals 4. Furthermore, solenoid terminals 22 of the solenoid valves 2 and a motor terminal 7 are connected with the board 5.

The spacer 8 is made of elastic material such as urethane and is located between the solenoids 21 and the board 5. In addition, the board 5 and the spacer 8 are held by the solenoids 21 and the case 3.

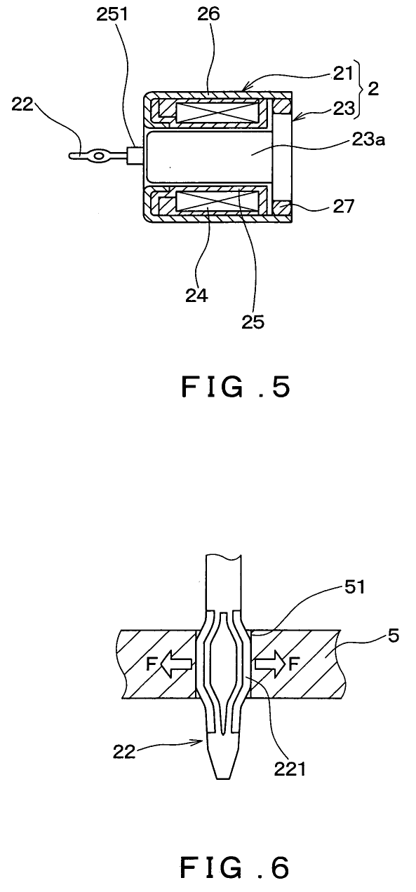

Next, the solenoids 21 of the solenoid valves 2 are described with reference to FIG. 5. Most parts of the valve units 23 are located in the body 1. Each of the valve units 23 includes a sleeve 23a, which is made of non-magnetic metal and protrudes from the body 1. Each of the valve units 23 is fixed to the body 1 by means of caulking.

Each of the solenoids 21 also includes a coil wire 24, a resin bobbin 25, a cylindrical yoke 26 made of magnetic metal, and a ring 27 made of magnetic metal. Each of the solenoids 21 is constructed by attaching the coil wire 24 to the bobbin 25, forming a periphery of the bobbin 25 by plastic molding, installing the bobbin 25 in the yoke 26, attaching the ring 27 to an opening at an end of the yoke 26, and connecting the coil wire 24 and the corresponding solenoid terminal 22 by means of soldering. In every one of all (eight in number in this instance) the solenoid valves 2, a terminal guide 251 for holding the corresponding solenoid terminal 22 is integrally formed with the bobbin 25 and holds the solenoid terminal 22.

As shown in FIG. 6, each of the solenoid terminals 22 includes a press fit terminal which is fixed to the board 5 by press fitting. The press fit terminal includes an insertion portion 221. The insertion portion 221 is inserted to an insertion hole 51 of the board 5 and generates an expansion force F, since the insertion portion 221 is made to have a larger diameter than that of the insertion hole 51. The connector terminals 4 and the motor terminal 7 are also fixed to the board 5 by press fitting in a manner similar to that of the solenoid terminals 22.

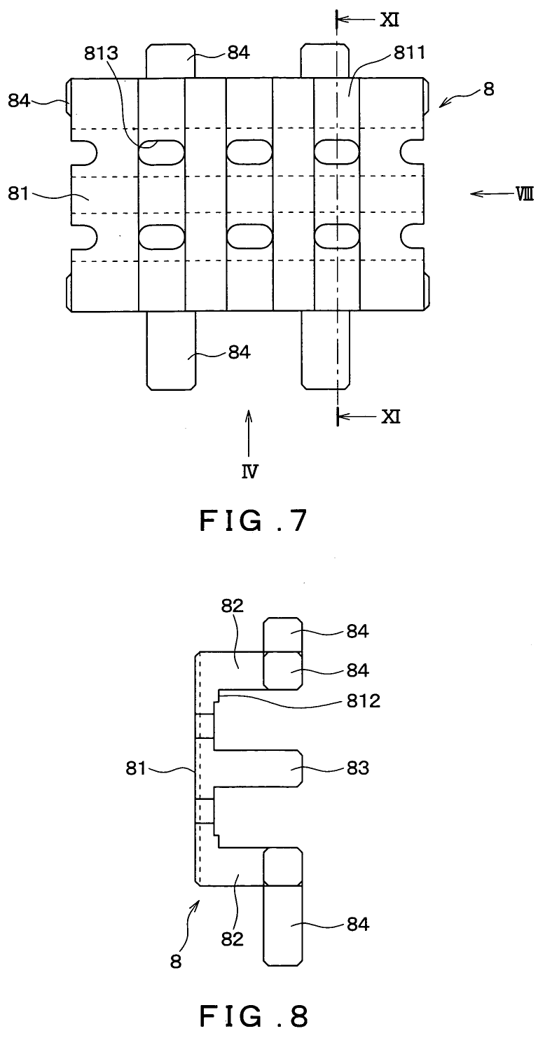

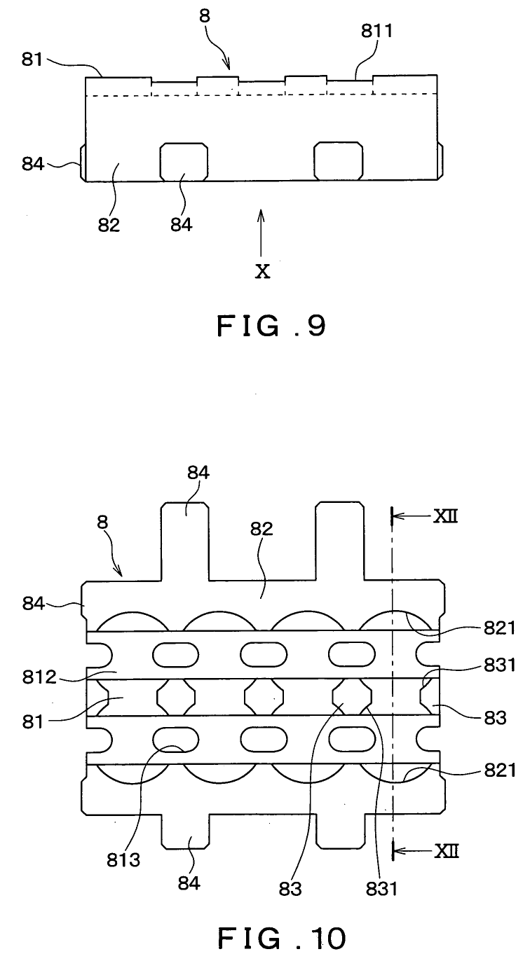

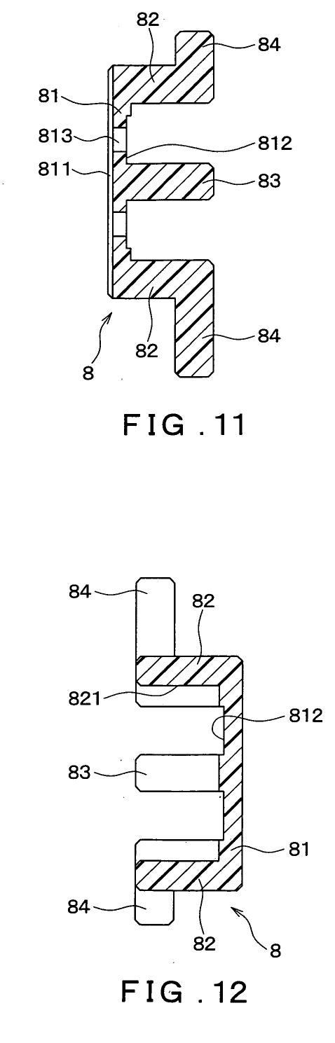

Hereinafter, a detailed description is given of the spacer with reference to FIGS. 7 to 12.

The spacer 8 includes a sandwiched portion 81 which has a shape of a plate and is held between the solenoids 21 and the board 5. A first surface of the sandwiched portion 81 comes in contact with a reverse side surface 55 of the board 5, and a second surface of the sandwiched portion 81 comes in contact with a surface of each of the yokes 26 of the solenoids 21. Another side of each of the yokes 26 comes in contact with the body 1.

Diversion grooves 811 are formed in three rows at the first surface of the sandwiched portion 81 in order to prevent the sandwiched portion 81 from interfering with soldered portions of the reverse side surface 55 of the board 5. Diversion grooves 812 are formed in two rows at the second surface of the sandwiched portion 81 in order to prevent the sandwiched portion 81 from interfering with tip portions of the sleeves 23a of the valve unit 23. A plurality of insertion holes 813 are formed at the sandwiched portion 81. The insertion holes 813 are penetration holes to which the solenoid terminals 22 are inserted, respectively.

The spacer 8 includes two types of guide portions 82 and 83 which extend from the sandwiched portion 81 along the axes of the solenoids 21 to the body 1 and hold an outer peripheral surface of the yokes 26 of the solenoids 21.

The first guide portions 82 have a shape of a plate and arranged parallel to each other at both ends of the sandwiched portion 81. Guide surfaces 821 are formed at each of the first guide portions 82. Each of the guide surfaces 821 has a shape of an arc and comes in contact with a periphery surface of the corresponding yoke 26.

The second guide portions 83 have a shape of a pillar and arranged at places in the middle of the two first guide portions 82. Guide surfaces 831 are formed at each of the second guide portions 83. Each of the guide surfaces 831 has a shape of an arc and comes in contact with a periphery surface of the corresponding yoke 26.

Each of the solenoids 21 is held by one of the guide surfaces 821 and two of the guide surfaces 831.

The spacer 8 includes a plurality of arm portions 84, each of which has a shape of a pillar and extends from the corresponding first guide portion 82 to a side surface of the case 3 facing the peripheries of the solenoids 21. The tip of each of the arm portions 84 comes in touch with the corresponding side surface.

The fluid pressure control device having the structure described above is composed as follows. First, the solenoid valve units 23, the pump, the motor, and the like are installed to the body 1. At this time, the body 1 is caulked so that the valve units 23 are fixed to the body 1 as a single body.

In the mean time, the solenoids 21 are inserted in a space formed by the guide surfaces 821 and 831, as well as the solenoid terminals 22 are respectively inserted to the insertion holes 813 of the sandwiched portion 81. Then, the tips of the solenoid terminals 22 are respectively inserted to the insertion holes 51 of the board 5 with the spacer 8 located between the board 5 and the solenoids 21. Thus, a primary collective is formed to which the board 5, the solenoids 21, and the spacer 8 are incorporated.

Next, the primary collective is inserted into the solenoid housing 32 and pushed until the board 5 comes in contact with the pillars 38 of the case 3. Accordingly, the connector terminals 4 are pressed into the insertion holes 51 of the board 5, and a secondary collective is formed to which the primary collective and the case 3 are incorporated. It is possible to prevent the primary collective from falling off from the case 3 since the connector terminals 4 are pressed into the insertion holes 51 of the board 5.

In the secondary collective, the arm portions 84 of the spacer 8 are compressed, and the guide surfaces 821 and 831 are pressed against the outer peripheral surfaces of the yokes 26. Therefore, it is possible to prevent the primary collective from falling off from the case 3. In addition, friction forces between the guide portions 82, 83 and the yoke 26 restricts a relative displacement between the board 5 and the solenoids 21 along the axes of the solenoids 21. In addition, the guide portions 82, 83 prevent the solenoid 21 from wobbling relative to the board 5 and accordingly prevent the solenoid terminals 22 from being bent by vibrations of the solenoids 21 in, for example, delivering the primary collective.

In the secondary collective, the tips of the insertion portions 221 of the solenoid terminals 22 are pressed into the insertion holes 51 of the board 5, while the sandwiched portion 81 is barely compressed. In addition, a surface (i.e. a body 1 side surface) of each of the yokes 26 protrudes from the solenoid housing 32.

Next, the secondary collective is attached to the body 1. More specifically, the solenoids 21 of the secondary collective are externally fitted to the sleeves 23a of the valve units 23, and the case 3 of the secondary collective is fixed to the body 1 by means of the screws 6.

As described above, the body 1 side surface of each of the yokes 26 protrudes from the solenoid housing 32. Therefore, the sandwiched portion 81 is compressed by an amount corresponding to the amount of the protrusion of the yokes 26 when the secondary collective is attached to the body 1. At this time, the solenoids 21 are displaced relative to the board 5, and the insertion portions 221 of the solenoid terminals 22 are pressed into the insertion hole 51 of the board 5 by a designated depth.

Then, wobbling of the solenoid 21 is prevented since a bouncing force of the sandwiched portion 81 pushes the solenoid 21 against the body 1. Connecting portions between the solenoid terminals 22 and the board 5 are therefore secured.

In the present embodiment, the solenoids 21 and the board 5 are located in the unpartitioned chamber 31. Therefore, it is possible to disuse a conventional partitioning wall and a conventional cover for covering the partitioning wall. As a result, the fluid pressure control device can be made with a smaller size and lower cost.

Accordingly, sealing of the fluid pressure control device becomes more reliable since portions which need sealing decreases.

### Second Embodiment

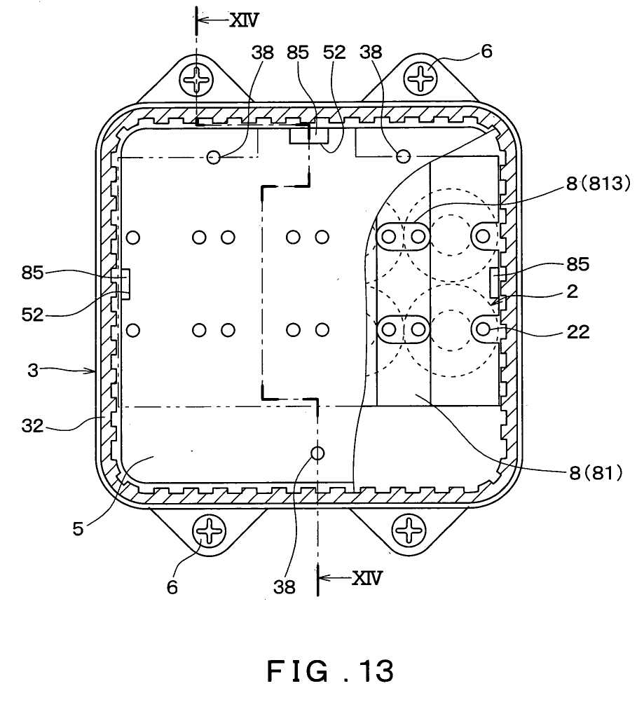

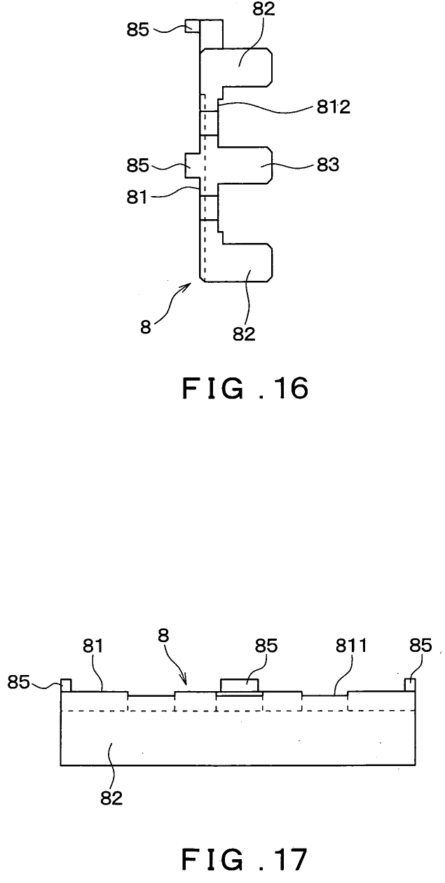

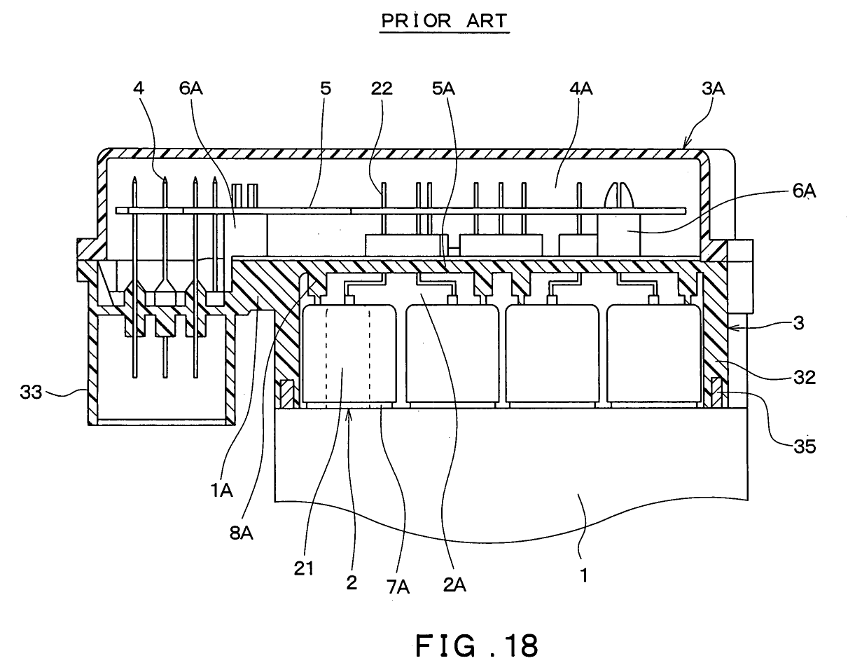

Hereinafter, a second embodiment of the present invention is described with reference to FIGS. 13 to 17. A part shown in this embodiment is identical or equivalent to a part in the first embodiment if the same reference numeral is applied to the two parts. Descriptions for such a part are omitted in this embodiment.

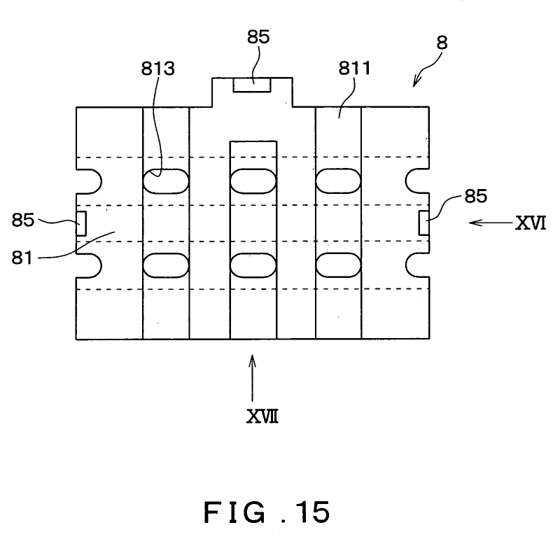

As shown in FIGS. 15 to 17, three protrusion portions 85 are formed at outer periphery of the sandwiched portion 81. Each of the protrusion portions 85 protrudes from a surface of the sandwiched portion 81 toward the board 5. In the spacer 8 of the present embodiment, the arm portions 84 in the first embodiment are disused. Therefore, the spacer 8 of the present embodiment can be manufactured with a smaller size.

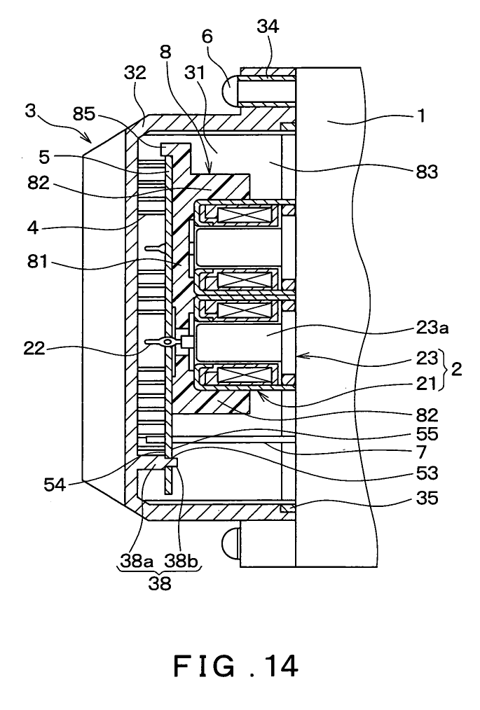

As shown in FIGS. 13 and 14, three recessed portions 52 are formed at an outer periphery of the board 5. The protrusion portions 85 can be fitted in the recessed portions 52, respectively. The board 5 and the spacer 8 are connected with each other when the protrusion portions 85 are pressed into the recessed portions 52.

Each of the pillars 38 includes a large diameter pillar 38a protruding toward the board 5 and a small diameter pillar 38b extending further from an end of the large diameter pillar 38a. The diameter of the large diameter pillar 38a is sufficiently larger than that of a plurality of insertion holes 53 to which the pillars 38 are inserted. In contrast, the diameter of the small diameter pillar 38b is smaller than that of the large diameter pillar 38a and is equivalent to that of the insertion holes 53.

In composing the fluid pressure control device, the primary collective to which the board 5, the solenoids 21, and the spacer 8 are incorporated is located in the solenoid housing 32 of the case 3. Then the primary collective is pressed until an end of each of the large diameter pillars 38a comes in contact with the board 5. Thus, the small diameter pillars 38b are pressed or inserted into the insertion holes 53, and the board 5 is located at a proper position with respect to the case 3.

### Other Embodiments

In the above embodiments, the fluid pressure control device is used for the vehicular brake device. However, the present invention can be applied to a fluid pressure control device used for other purposes.

What is claimed is:

1. A fluid pressure control device comprising:
a body in which fluid flows;
a solenoid valve including:
a valve unit for allowing and blocking flow of the fluid; and
a solenoid externally fitted to the valve unit in a detachable manner;
a solenoid terminal connected with the solenoid;
a board including a surface on which an electrical element is arranged, the board connected with the solenoid terminal;
a spacer including elastic material, the spacer located between the solenoid and the board; and
a case attached to the body, the case accommodating the solenoid, the board, and the spacer,
wherein the board and the spacer are held between the solenoid and the case.

2. The fluid pressure control device according to claim 1, wherein the spacer includes a sandwiched portion, the sandwiched portion located between the board and a surface of the solenoid, the sandwiched portion compressed.

3. The fluid pressure control device according to claim 2, wherein the spacer includes a guide portion extending from the sandwiched portion in an axial direction of the solenoid and holding an outer periphery of the solenoid.

4. The fluid pressure control device according to claim 3, wherein the spacer includes an arm portion extending from the guide portion to a side face of the case, the side face facing the outer periphery of the solenoid, the arm portion including a tip portion coming in contact with the side face.

5. The fluid pressure control device according to claim 4, wherein the arm portion is compressed.

6. The fluid pressure control device according to claim 1, wherein:
the spacer includes a protrusion portion;
the board includes a recessed portion; and
the protrusion portion is fitted in the recessed portion and the board is accordingly connected with the spacer.

7. The fluid pressure control device according to claim 6, wherein the case includes a pillar inserted to a hole formed at the board.

8. The fluid pressure control device according to claim 1, wherein the solenoid terminal is a press fit terminal.

9. The fluid pressure control device according claim 1, wherein:
the fluid pressure control device is incorporated to a vehicle; and
brake fluid flows in the body.

10. A method for composing a fluid pressure control device,
the fluid pressure control device including:
a body in which fluid flows;
a solenoid valve including:
a valve unit for allowing and blocking flow of the fluid; and
a solenoid externally fitted to the valve unit in a detachable manner;
a solenoid terminal connected with the solenoid;
a board including a surface on which an electrical element is arranged, the board connected with the solenoid terminal;
a spacer including elastic material, the spacer located between the solenoid and the board; and
a case attached to the body, the case accommodating the solenoid, the board, and the spacer,
wherein the board and the spacer are held between the solenoid and the case,
the method includes:
a first step for obtaining a first collective in which the solenoid, the board, and the spacer are combined together, the first step including:
disposing the spacer between the solenoid and the board; and
inserting the solenoid terminal to a hole formed at the board;
a second step for obtaining a second collective, including:
locating the first collective in the case; and
forming the second collective by combining the first collective and the case; and
a third step for combining the second collective to the body.
